(19) United States
(12) Patent Application Publication
(10) Pub. No.: US 2023/0163998 A1
(43) Pub. Date: May 25, 2023

(54) DATA PROCESSING METHOD, DEVICE, ELECTRONIC DEVICE AND COMPUTER READABLE MEDIUM

(71) Applicants: SHENZHEN CIMC INTELLIGENT TECHNOLOGY CO., LTD, Shenzhen (CN); GUANGDONG CIMC INTELLIGENT TECHNOLOGY CO., LTD, Dongguan (CN)

(72) Inventors: Jieyin LV, Shenzhen (CN); Shouqin ZHOU, Shenzhen (CN); Yulong ZHAO, Shenzhen (CN); Jichun LI, Shenzhen (CN)

(21) Appl. No.: 18/153,310

(22) Filed: Jan. 11, 2023

Related U.S. Application Data
(63) Continuation of application No. PCT/CN21/97584, filed on Jun. 1, 2021.

(30) Foreign Application Priority Data
Jun. 24, 2020 (CN) 202010592464.1

(51) Int. Cl. H04L 12/46; H04L 47/6275; H04L 47/2441

(52) U.S. Cl. CPC H04L 12/4633; H04L 47/6275; H04L 47/2441; H04L 2212/00

(57) ABSTRACT

The data processing method comprises the following steps: detecting, in response to a data packet from a target smart logistics device, the type of communication link between the intermediate server and the target smart logistics device; determining a target communication protocol in the transmission of the data packet, based on the type of communication link between the intermediate server and the target smart logistics device; parsing the data packet based on the target communication protocol to obtain parsed data; encapsulating the parsed data according to a communication protocol corresponding to the type of the communication link between the intermediate server and the logistics data server to generate an encapsulated data packet.

### CROSS REFERENCE TO RELATED APPLICATION(S)

This application is a continuation of International Application No. PCT/CN2021/097564, filed Jun. 1, 2021, which claims priority to Chinese Patent Application No. 202010592464.1, filed Jun. 24, 2020, the entire disclosures of which are incorporated herein by reference.

### TECHNICAL FIELD

The present application relates to the field of computer technology and, specifically, to a data processing method, device, computer readable medium and electronic device.

### BACKGROUND

The logistics data server is used to provide corresponding business services to the smart logistics equipment, so that the user can better control the smart logistics equipment through the logistics data server.

In order to better serve several types of smart logistics equipment, logistics data servers need to support various types of smart logistics equipment and multiple communication link types between each type of smart logistics equipment and logistics data servers. Logistics data servers generally support various types of smart logistics devices by developing functional modules, which can seriously increase the system load of logistics data servers as the types of smart logistics devices increase, leading to redundancy of functional modules of logistics data servers. In addition, when new types of smart logistics equipment are added, it will make it necessary to update and maintain the smart logistics equipment from time to time, which in turn affects the normal use of other types of smart logistics equipment.

### SUMMARY

There is provided a data processing method, device, computer readable medium and electronic device that may enable a logistics data server to support various types of smart logistics equipment and various communication link types between the smart logistics equipment and the logistics data server, and the system load of a logistics data service platform can also be reduced.

Other features and advantages of the present application will become apparent through the following detailed description or will be learned in part through the practice of the present invention.

According to an aspect of an embodiment of the present application, there is provided a data processing method comprising: detecting, in response to a data packet from a target smart logistics device, the type of communication link between the intermediate server and the target smart logistics device; determining a target communication protocol in the transmission of the data packet, based on the type of communication link between the intermediate server and the target smart logistics device; parsing the data packet based on the target communication protocol to obtain parsed data; encapsulating the parsed data according to a communication protocol corresponding to the type of the communication link between the intermediate server and the logistics data server to generate an encapsulated data packet; and sending the encapsulated data packet to the logistics data server via the communication link between the intermediate server and the logistics data server.

According to an aspect of an embodiment of the present application, there is provided a storage device for storing one or more programs which, when the one or more programs are executed by the one or more processors, causes the one or more processors to implement a data processing method comprising: detecting, in response to a data packet from a target smart logistics device, the type of communication link between the intermediate server and the target smart logistics device; determining a target communication protocol in the transmission of the data packet, based on the type of communication link between the intermediate server and the target smart logistics device; parsing the data packet based on the target communication protocol to obtain parsed data; encapsulating the parsed data according to a communication protocol corresponding to the type of the communication link between the intermediate server and the logistics data server to generate an encapsulated data packet; and sending the encapsulated data packet to the logistics data server via the communication link between the intermediate server and the logistics data server.

According to an aspect of an embodiment of the present application, there is provided a computer readable medium having a computer program stored thereon, wherein the computer program when executed by a processor implements a data processing method comprising:

detecting, in response to a data packet from a target smart logistics device, the type of communication link between the intermediate server and the target smart logistics device;

determining a target communication protocol in the transmission of the data packet, based on the type of communication link between the intermediate server and the target smart logistics device;

parsing the data packet based on the target communication protocol to obtain parsed data; encapsulating the parsed data according to a communication protocol corresponding to the type of the communication link between the intermediate server and the logistics data server to generate an encapsulated data packet; and sending the encapsulated data packet to the logistics data server via the communication link between the intermediate server and the logistics data server.

It should be understood that the above general description and the later detailed descriptions are exemplary and explanatory only and do not limit the present application.

### BRIEF DESCRIPTION OF THE DRAWINGS

The drawings herein are incorporated into the specification and form a part of the specification, showing embodiments in accordance with the disclosure, and are used together with the specification to explain the principles of the disclosure. It will be apparent that the accompanying drawings in the following description are only some embodiments of the present disclosure, and that other drawings may be obtained from them without creative effort by one of ordinary skill in the art.

FIG. 1 illustrates a schematic diagram of an exemplary system architecture to which the technical solutions of embodiments of the present application may be applied;

FIG. 2 schematically illustrates a flowchart of a data processing method according to an embodiment of the present application;

FIG. 3 schematically illustrates a flowchart of a data processing method according to an embodiment of the present application;

FIG. 4 schematically illustrates a flowchart of a data processing method according to an embodiment of the present application;

FIG. 5 schematically illustrates a specific flow diagram of step S250 according to an embodiment of the present application;

FIG. 6 schematically illustrates a flowchart of a data processing method according to an embodiment of the present application;

FIG. 7 schematically illustrates a block diagram of a data processing device according to an embodiment of the present application; and

FIG. 8 illustrates a schematic diagram of the structure of a computer system suitable for implementing the electronic device of an embodiment of the present application.

### DETAILED DESCRIPTION

Example embodiments will now be described more fully with reference to the accompanying drawings. However, the example embodiments can be implemented in a variety of forms and should not be construed as being limited to the examples set forth herein; rather, providing these embodiments makes the present disclosure more comprehensive and complete and communicates the ideas of the example embodiments in a comprehensive manner to those skilled in the art. In addition, the described features, structures, or characteristics may be combined in any suitable manner in one or more embodiments. In the following description, many specific details are provided to give a full understanding of the embodiments of the present disclosure. However, those of skill in the art will realize that the technical embodiments of the present disclosure may be practiced without one or more of the specific details, or other methods, components, devices, steps, etc. may be employed. In other instances, well-known methods, devices, implementations, or operations are not shown or described in detail to avoid obscuring aspects of the present disclosure. The block diagrams shown in the accompanying drawings are only functional entities and do not necessarily have to correspond to physically separate entities. That is, these functional entities may be implemented in software form, or in one or more hardware modules or integrated circuits, or in different network and/or processor devices and/or micro-controller devices. The flowcharts shown in the accompanying drawings are only exemplary illustrations and are not necessarily all inclusive of the contents and operations/steps, nor are they necessarily performed in the order depicted. For example, some operations/steps may also be decomposed, while some operations/steps may be combined or partially combined, so the actual order of execution may change depending on the actual situation.

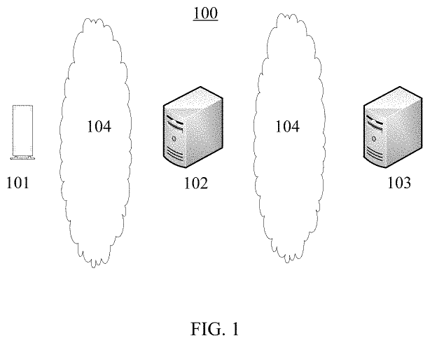

FIG. 1 illustrates a schematic diagram of an exemplary system architecture to which the technical solutions of embodiments of the present application may be applied.

As shown in FIG. 1, the system architecture 100 may include a smart logistics device 101, an intermediate server 102, a logistics data server 103, and a network 104. The network 104 is used as a medium for providing a communication link between the smart logistics device 101, the intermediate server 102, and the logistics data server 103. The network 104 may include various connection types, such as wired, wireless communication links or fiber optic cables, among others. It should be understood that the number of smart logistics devices, intermediate servers, logistics data servers, and networks in FIG. 1 is only schematic. There may be any number of smart logistics devices, networks, and servers depending on the implementation needs. For example, intermediate server 102 or logistics data server 103 may be a cluster of servers consisting of multiple servers, etc.

In the intermediate server 102, the intermediate server 102 detecting, in response to a data packet from a target smart logistics device 101, the type of communication link between the intermediate server 102 and the target smart logistics device 101; determining a target communication protocol in the transmission of the data packet, based on the type of communication link between the intermediate server 102 and the target smart logistics device 101; parsing the data packet based on the target communication protocol to obtain parsed data; encapsulating the parsed data according to a communication protocol corresponding to the type of the communication link between the intermediate server 102 and the logistics data server 103 to generate an encapsulated data packet; and sending the encapsulated data packet to the logistics data server 103 via the communication link between the intermediate server 102 and the logistics data server 103.

As can be seen, the technical solution of the present application embodiment may enable the logistics data server to support various types of smart logistics equipment and various communication link types between the smart logistics equipment and the logistics data server, and the system load of a logistics data service platform can also be reduced.

The data processing method provided in the embodiment of the present application is generally performed by the intermediate server 102. However, it is readily understood by a person skilled in the art that the data processing method provided by the embodiments of the present application may also be performed by the logistics data server 103 to perform the data processing method in the present exemplary embodiment, without special limitation.

The following details of the implementation of the technical solutions of this application embodiment are elaborated.

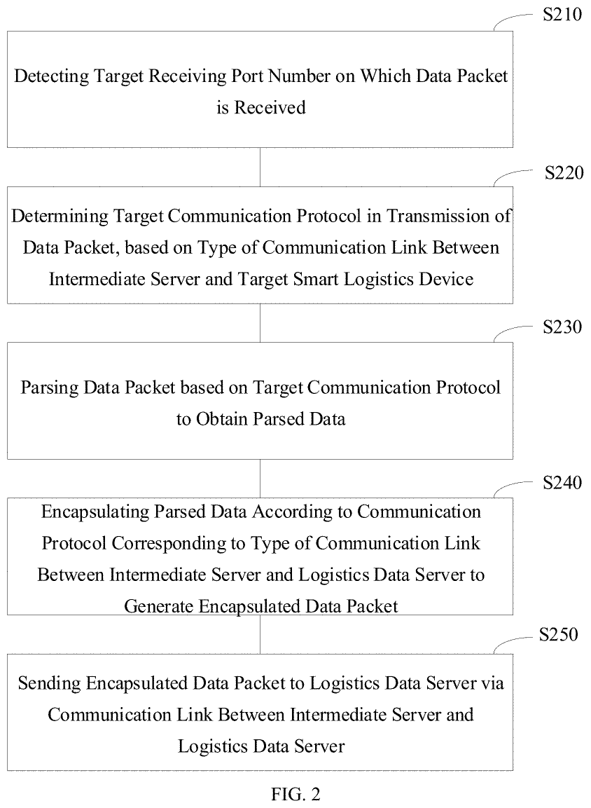

FIG. 2 schematically illustrates a flowchart of a data processing method according to an embodiment of the present application, which can be performed by an intermediate server 102 as shown in FIG. 1, and the present embodiment is illustrated by an intermediate server to perform it as an example. Referring to FIG. 2, the data processing method comprises at least steps S210 to S250, as described in detail as follows.

In step S210, detecting, in response to a data packet from a target smart logistics device, the type of communication link between the intermediate server and the target smart logistics device.

In one embodiment, the smart logistics device is a logistics device that can be smartly controlled, specifically a logistics device that can achieve a specific function such as sorting, handling, storage, etc. The smart logistics equipment can receive control instructions from or upload its own data to the corresponding intermediate server, which in turn forwards it to the logistics data server, thereby achieving a communication connection with the logistics data server.

The communication link is the link between the smart logistics equipment and the intermediate server for communication connection, and the communication link between the smart logistics equipment and the intermediate server may include LPWA (Low-Power Wide-Area) cellular communication link, 5G global mobile communication system communication link, radio frequency identification (RFID, Radio Frequency Identification) communication link and satellite communication link The satellite communication link can specifically include Orbcomm satellite communication link, SkyQuest satellite communication link, traveling cloud satellite communication link and other low-orbit satellite communication links, etc., without limitation herein. The data packet is a data packet sent by the smart logistics device to the intermediate server through any of the above-mentioned types of communication links.

The intermediate server may detect the type of communication link between the intermediate server and the target smart logistics device when it receives a data packet from any of the target smart logistics devices.

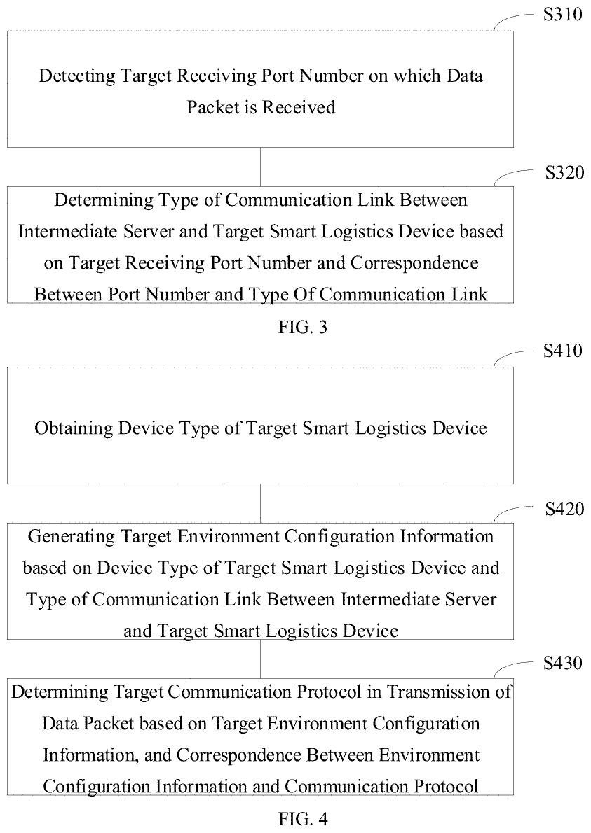

Referring to FIG. 3. FIG. 3 schematically illustrates a flowchart of a data processing method according to an embodiment of the present application. As shown in FIG. 3, the step of detecting a communication link type between an intermediate server and a target smart logistics device may specifically include steps S310 to S320, as described in detail below,

In step S310, detecting a target receiving port number on which the data packet is received. In one embodiment, the receiving port is a specific functional module for receiving packets in the intermediate server, and for different types of communication links, the intermediate server will receive data packets from the target smart logistics device through different receiving ports, and the receiving port number is some kind of identification information that uniquely identifies the different receiving ports, and the identification information can specifically be the number of the receiving port or the device identification of the receiving port, without limitation here. In determining the type of communication link between the intermediate server and the target smart logistics device, the target receiving port of the received data packet can be monitored and the receiving port number corresponding to the target receiving port can be obtained.

In step S320, determining the type of communication link between the intermediate server and the target smart logistics device based on the target receiving port number and the correspondence between the port number and the type of communication link.

In one embodiment, the intermediate server may pre-stores the correspondence between the receive port numbers of different receive ports and the corresponding communication link types, and the intermediate server determines the communication link types between the intermediate server and the target smart logistics device based on the determined receive port numbers of the target receive ports and the above correspondence.

In the technical solution of the embodiment shown in FIG. 3, by establishing the correspondence between the receiving port number corresponding to each different receiving port and the communication link type in advance, a fast and accurate determination of the communication link type between the intermediate server and the target smart logistics device may be achieved, and the efficiency of data processing may be improved.

In step S220, determining a target communication protocol in the transmission of the data packet, based on the type of communication link between the intermediate server and the target smart logistics device.

In one embodiment, there is an association between the communication link type between the intermediate server and the target smart logistics device and the target communication protocol employed in the transmission of the data packet, and after determining the communication link type between the intermediate server and the target smart logistics device, the target communication protocol employed in the transmission of the data packet may be determined based on the determined communication link type and the above association to facilitate the parsing process of the data packet. It is understood that since the same communication link type may correspond to a plurality of different communication protocols, the determined target communication protocol may be one or more.

Referring to FIG. 4. FIG. 4 schematically illustrates a flowchart of the step S220 of a data processing method according to an embodiment of the present application. As shown in FIG. 4, step S220 may specifically include steps S410 to S430, as described in detail below.

In step S410, obtaining a device type of the target smart logistics device.

Since the same type of communication link can correspond to a variety of different communication protocols, and in the case of communication between intelligent logistics equipment of different equipment types and intermediate servers using the same type of communication link, the corresponding communication protocols will differ under the premise that the equipment types of intelligent logistics equipment are different. Therefore, it is necessary to determine the target communication protocol employed in the transmission of data packets based on the type of equipment of the intelligent logistics equipment and the type of communication link between the two types of information of the intelligent logistics equipment and the intermediate server for the transmission of data packets.

Optionally, the device identification of the target smart logistics device may be obtained, and the device type of the target smart logistics device is determined based on the device identification of the target smart logistics device.

In step S420, generating target environment configuration information based on a device type of the target smart logistics device and the type of communication link between the intermediate server and the target smart logistics device.

In one embodiment, after obtaining the device type of the target smart logistics device and the communication link type between the intermediate server and the target smart logistics device, the target environment configuration information corresponding to the target smart logistics device may be generated based on these two types of information, and the target communication protocol employed in the transmission of the data packet can be determined based on this environment configuration information. It is understood that the intermediate server may have pre-stored correspondence between the environmental configuration information corresponding to diverse types of smart logistics devices and the communication protocol employed in the transmission of the data packet, so as to facilitate determining the communication protocol employed in the transmission based on the environmental configuration information.

In step S430, determining a target communication protocol in the transmission of the data packet based on the target environment configuration information, and the correspondence between the environment configuration information and the communication protocol.

In one embodiment, the intermediate server may look up in the correspondence between the pre-stored environmental configuration information and the communication protocol based on the generated target environmental configuration information as an index to determine the target communication protocol employed in the transmission of the data packet from the target smart logistics device.

In the technical solution of the embodiment shown in FIG. 4, by storing the correspondence between different environmental configuration information and the communication protocol employed in the transmission of data packet, it enables the intermediate server to support smart logistics devices of different device types, to more quickly determine the target communication protocol employed in the transmission of data packet, and to improve the efficiency of data processing.

In step S230, parsing the data packet based on the target communication protocol to obtain parsed data.

In one embodiment, after determining the target communication protocol employed in the transmission of the data packet of the target smart logistics device, in order to enable the logistics data server to receive and parse the data packet smoothly, it is necessary to parse the data packet according to the determined target communication protocol and obtain the parsed data.

Optionally, the data packet may be specifically parsed according to the parsing function corresponding to the target communication protocol to obtain the parsed data.

In step S240, encapsulating the parsed data according to a communication protocol corresponding to the type of the communication link between the intermediate server and the logistics data server to generate an encapsulated data packet.

In one embodiment, the communication link type between the intermediate server and the logistics data server is a communication link of a type agreed in advance between the intermediate server and the logistics data server. After the intermediate server gets the parsed data, in order to facilitate sending the parsed data to the logistics data server and to enable the logistics data server to read the parsed information, the parsed data can be encapsulated according to the communication protocol corresponding to the communication link type between the intermediate server and the logistics data server to generate an encapsulated data packet,

In step S250, sending the encapsulated data packet to the logistics data server via the communication link between the intermediate server and the logistics data server.

In one embodiment, the intermediate server sends the encapsulated data packet to the logistics data server via the communication link between the intermediate server and the logistics data server, specifically, the encapsulated packet may be sent to the logistics data server based on the sending port corresponding to the communication link between the intermediate server and the logistics data server.

FIG. 5 schematically illustrates a flowchart of the step S250 of a data processing method according to an embodiment of the present application. As shown in FIG. 5, step S250 may specifically include steps S510 to S530, as described in detail below.

In step S510, generating a write message packet based on the encapsulated packet.

In step S520, adding the write message packet to a message delivery queue.

In step S530, sending the write message packet contained in the message sending queue to the logistics data server via the communication link between the intermediate server and the logistics data server.

In one embodiment, the intermediate server generates corresponding write message packets based on the encapsulated data packet as the data packet to be sent when sending the encapsulated packet to the logistics data server. The intermediate server adds all the generated message packets to the message sending queue and sends all the write message packets in the message sending queue to the logistics data server by the thread that sends the messages.

Specifically, the intermediate server sends the write message packets contained in the message sending queue to the logistics data server via the communication link with the logistics data server for communication connection.

By generating write message packets according to the encapsulated data packet and adding the generated write message packets to the message sending queue, it may effectively enable the intermediate server to send write messages corresponding to multiple smart logistics devices to the logistics data server in an orderly manner to avoid missing write message packets.

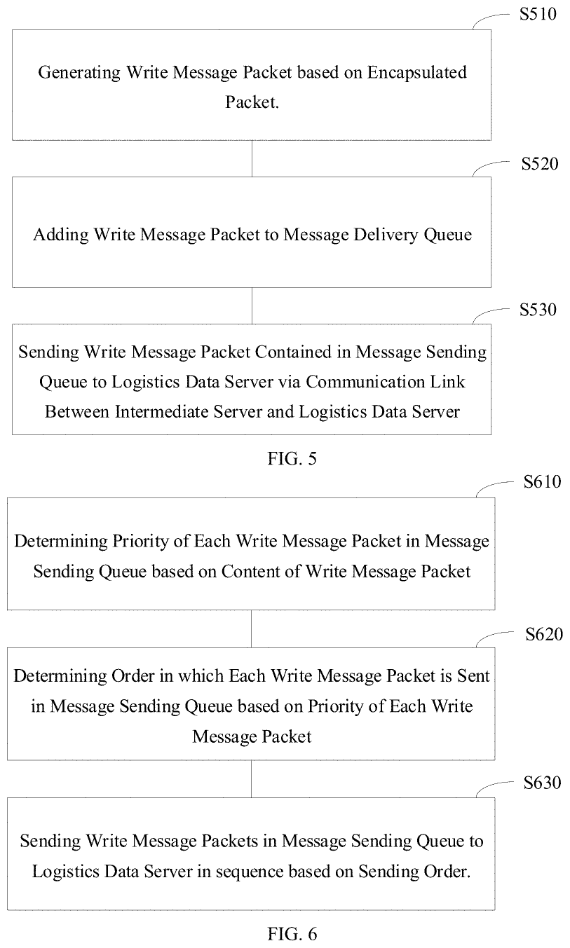

FIG. 6 schematically illustrates a flow chart of a data processing method according to an embodiment of the present application, and with reference to FIG. 6, the step of sending a write message packet contained in a message sending queue to the logistics data server may specifically include steps S610 to S630, as described in detail below.

In step S610, determining the priority of each write message packet in the message sending queue based on the content of the write message packet.

In one embodiment, the intermediate server determines the priority of each write message packet in the message sending queue based on the content of the write message packet when the write message packets contained in the message sending queue are sent to the logistics data server. For write message packets with different functional types, the corresponding priorities are different, for example, write message packets of the warning alert type or the device maintenance type have a high priority, such as write message packets of the data storage type have a low priority. Optionally, the priority of write message packets may be specifically divided into three levels: high priority, medium priority, and low priority, or of course, more than three levels of priority according to demand.

Optionally, when determining the priority of individual write message packets in the message sending queue based on the content of the write message packets, the priority of individual write message packets may be determined based on the specific fields contained in the content of the write message packets and the correspondence between the specific fields and the priority.

In step S620, determining the order in which each write message packet is sent in the message sending queue based on the priority of each write message packet.

In one embodiment, when determining the delivery order of each write packet in the message delivery queue based on the priority of each write packet, the write message packet with the higher priority is sent in the first order. It should be noted that for two write message packets with the same priority, the delivery order can be determined based on the time when the write message packet is added to the message delivery queue, for example the write message packet added to the message delivery queue at an earlier time has the first delivery order.

In step S630, sending the write message packets in the message sending queue to the logistics data server in sequence based on the sending order.

In one embodiment, the intermediate server sequentially sends the write message packets in the message sending queue to the logistics data server based on the order of sending to the logistics data server.

In the technical solution of the embodiment shown in FIG. 6, based on the priority of each write message packet, the order of sending each write message packet in the message sending queue is determined, and it may be realized that based on the importance of each write message packet, the write message packet with high importance is sent to the logistics data server first, so as to meet more complex business scenarios and improving the application scenarios of the solution.

The following describes the device embodiment of the present application, which can be used to perform the data processing method of the above-described embodiment of the present application. For details not disclosed in the device embodiment of the present application, please refer to the embodiment of the data processing method described above in the present application.

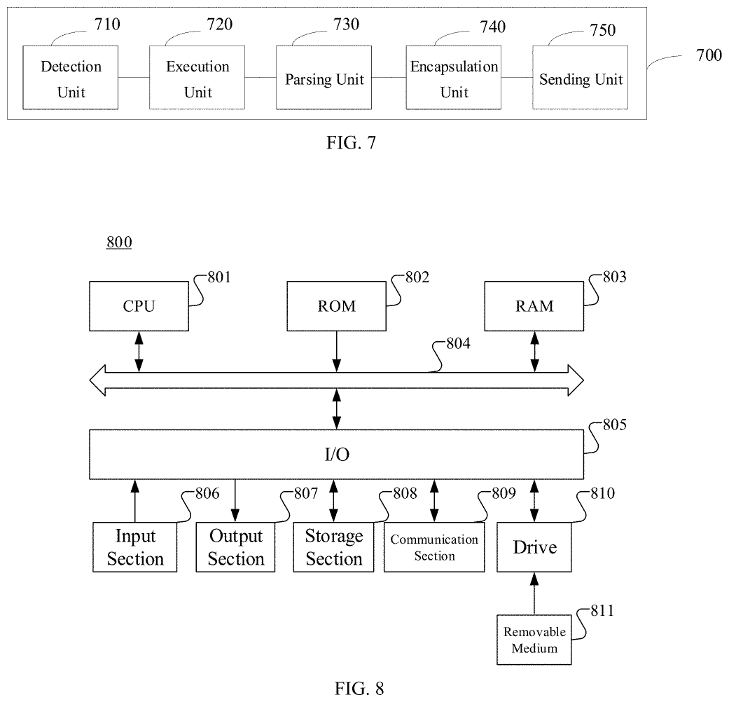

FIG. 7 schematically illustrates a block diagram of a data processing device according to an embodiment of the present application. Referring to FIG. 7, a data processing device 700 according to an embodiment of the present application, includes: a detection unit 710, an execution unit 720, a parsing unit 730, an encapsulation unit 740, and a sending unit 750.

Among them, the detection unit 710 is configured for detecting, in response to a data packet from a target smart logistics device, the type of communication link between the intermediate server and the target smart logistics device; the execution unit 720 is configured for determining a target communication protocol in the transmission of the data packet, based on the type of communication link between the intermediate server and the target smart logistics device; the parsing unit 730 is configured for parsing the data packet based on the target communication protocol to obtain parsed data; the encapsulation unit 740 is configured for encapsulating the parsed data according to a communication protocol corresponding to the type of the communication link between the intermediate server and the logistics data server to generate an encapsulated data packet; and the sending unit is configured for sending the encapsulated data packet to the logistics data server via the communication link between the intermediate server and the logistics data server.

In one embodiments of the present application, the detection unit 710 comprises: a detection subunit, configured for detecting a target receiving port number on which the data packet is received; and a first execution subunit, configured for determining the type of communication link between the intermediate server and the target smart logistics device based on the target receiving port number and the correspondence between the port number and the type of communication link. In one embodiments of the present application, the execution unit 720 comprises: an acquisition subunit, configured for obtaining a device type of the target smart logistics device; a first generation subunit, configured for generating target environment configuration information based on a device type of the target smart logistics device and the type of communication link between the intermediate server and the target smart logistics device; and a second execution subunit, configured for determining a target communication protocol in the transmission of the data packet based on the target environment configuration information, and the correspondence between the environment configuration information and the communication protocol.

In one embodiments of the present application, the sending unit 750 comprises: a second generation subunit, configured for generating a write message packet based on the encapsulated packet; an add subunit, configured for adding the write message packet to a message delivery queue; and a sending subunit, configured for sending the write message packet contained in the message sending queue to the logistics data server via the communication link between the intermediate server and the logistics data server.

In one embodiments of the present application, the sending subunit comprises: a preference level determination subunit, specifically configured for determining the priority of each write message packet in the message sending queue based on the content of the write message packet; a sending order determination subunit, configured for determining the order in which each write message packet is sent in the message sending queue based on the priority of each write message packet; and a sending subunit, configured for sending the write message packets in the message sending queue to the logistics data server in sequence based on the sending order.

In the technical solution provided in some embodiments of the present application, it may enable the logistics data server to support various types of communication link types between different smart logistics devices and different smart logistics devices and the logistics data server, and to effectively reduce the system load of the logistics data service platform while supporting various types of communication links between different intelligent logistics devices and different intelligent logistics devices and the logistics data server.

FIG. 8 illustrates a schematic diagram of the structure of a computer system suitable for implementing the electronic device of an embodiment of the present application.

It should be noted that the computer system 800 of the electronic device illustrated in FIG. 8 is only an example and should not impose any limitations on the functionality and scope of use of embodiments of the present application.

As shown in FIG. 8, the computer system 800 includes a Central Processing Unit (CPU) 801 that may perform various appropriate actions and processes, such as performing the methods described in the embodiments above, based on a program stored in Read-Only Memory (ROM) 802 or loaded into Random Access Memory (RAM) 803 from storage section 808. In RAM 803, various programs and data required for system operation are also stored. The CPU 801, ROM 802, and RAM 803 are connected to each other via bus 804. The input/output (Input/Output, I/O) interface 805 is also connected to the bus 804.

The following components are connected to the I/O interface 805: an input section 806 including keyboard, mouse, etc.; an output section 807 including, for example, Cathode Ray Tube (CRT), Liquid Crystal Display (LCD), etc., and speakers, etc.; a storage section 808 including hard disk, etc.; and a communication section 809 including a network interface card such as a LAN (Local Area Network) card, modem, etc. The communication section 809 performs communication processing via a network such as the Internet. The drive 810 is also connected to an I/O interface 805 as needed. Removable media 811, such as disks, CD, magnetic disks, semiconductor memory, etc., is mounted on the drive 810 as needed so that computer programs read from it can be mounted into the storage section 808 as needed.

In particular, according to embodiments of the present application, the process described below with reference to the flowchart may be implemented as a computer software program. For example, embodiments of the present application include a computer program product comprising a computer program carried on a computer readable medium, the computer program comprising program code for performing the method shown in the flowchart. In such an embodiment, the computer program may be downloaded and installed from a network via a communication section 809, and/or from a removable media 811. When this computer program is executed by the central processing unit (CPU) 801, various functions as defined in the system of this application are performed.

It is noted that the computer readable medium shown in this application embodiment may be a computer readable signal medium or a computer readable storage medium or any combination of the above. The computer readable storage medium may, for example, be—but is not limited to—an electrical, magnetic, optical, electromagnetic, infrared, or semiconductor system, device, or device, or any combination of the above. More specific examples of computer-readable storage media may include, but are not limited to: electrically connected with one or more wires, portable computer disks, hard disks, random access memory (RAM), read-only memory (ROM), Erasable Programmable Read Only Memory (EPROM), flash memory, optical fiber, portable compact disk read-only memory (Compact Disc Read-Only Memory (CD-ROM), optical memory devices, magnetic memory devices, or any suitable combination of the foregoing. In this application, a computer-readable storage medium may be any tangible medium that contains or stores a program that can be used by or in combination with an instruction execution system, device, or apparatus. And in the present application, the computer-readable signaling medium may include a data signal propagated in the baseband or as part of a carrier wave that carries computer-readable program code. Such propagated data signals may take a variety of forms, including but not limited to electromagnetic signals, optical signals, or any suitable combination of the foregoing. The computer-readable signal medium may also be any computer-readable medium other than a computer-readable storage medium that sends, propagates, or transmits a program for use by or in conjunction with an instruction execution system, device, or device. The program code contained on the computer-readable medium can be transmitted by any suitable medium, including but not limited to wireless, wired, etc., or any suitable combination of the above.

The flowcharts and block diagrams in the accompanying drawings illustrate possible implementations of the architecture, functionality, and operation of systems, methods, and computer program products in accordance with various embodiments of the present application. At this point, each box in a flowchart or block diagram may represent a module, program segment, or portion of code, and the module, program segment, or portion of code contains one or more executable instructions for implementing a specified logical function. It should also be noted that in some implementations as replacements, the functions indicated in the boxes may also occur in a different order than that indicated in the accompanying drawings. For example, two boxes represented one after the other can actually be executed in substantially parallel, and they may sometimes be executed in the opposite order, depending on the function involved. Note also that each box in a block diagram or flowchart, and the combination of boxes in a block diagram or flowchart, may be implemented with a dedicated hardware-based system that performs the specified function or operation, or may be implemented with a combination of dedicated hardware and computer instructions.

The units described in the embodiments involved in this application can be implemented by means of software, or by means of hardware, and the units described can also be set in a processor. Among other things, the names of these units do not in some cases constitute a limitation of the unit itself.

As another aspect, the present application also provides a computer readable medium which may be contained in the electronic device described in the above-described embodiments; or may be present alone and not assembled into such electronic device. The computer readable medium carries one or more programs that, when the one or more programs are executed by one of the electronic devices, cause the electronic device to implement the method described in the above-described embodiments.

It should be noted that although a number of modules or units of the apparatus for action execution are mentioned in the detailed description above, this division is not mandatory. In fact, according to the embodiments of the present application, the features and functions of two or more modules or units described above may be specified in a single module or unit. Conversely, the features and functions of one module or unit described above may be further divided to be specified by a plurality of modules or units.

With the above description of the implementation, it is readily understood by those skilled in the art that the example implementation described herein can be implemented by means of software or by means of software combined with the necessary hardware. Thus, the technical solution according to the present application embodiment may be embodied in the form of a software product that may be stored in a non-volatile storage medium (which may be a CD-ROM, USB flash drive, removable hard drive, etc.) or on a network, comprising a number of instructions to cause a computing device (which may be a personal computer, server, touch terminal, or network device, etc.) to perform the method according to the present application embodiment. The method of the present application.

Other embodiments of the present application will readily come to the mind of one skilled in the art upon consideration of the specification and practice of the application as disclosed herein. This application is intended to cover any variation, use, or adaptation of the invention that follows the general principles of this application and includes commonly known or customary technical means in the art that are not disclosed herein.

It is to be understood that the present application is not limited to the precise construction already described above and illustrated in the accompanying drawings, and that various modifications and changes may be made without departing from its scope. The scope of the present application is limited only by the appended claims.

What is claimed is:

1. A data processing method, applied to an intermediate server connected with a logistics data server, wherein the method comprises:
detecting, in response to a data packet from a target smart logistics device, a type of communication link between the intermediate server and the target smart logistics device;
determining a target communication protocol in a transmission of the data packet, based on the type of communication link between the intermediate server and the target smart logistics device;
parsing the data packet based on the target communication protocol to obtain parsed data;
encapsulating the parsed data according to a communication protocol corresponding to the type of the communication link between the intermediate server and the logistics data server to generate an encapsulated data packet; and
sending the encapsulated data packet to the logistics data server via the communication link between the intermediate server and the logistics data server.

2. The data processing method according to claim 1, wherein the detecting the type of communication link between the intermediate server and the target smart logistics device, comprises:
detecting a target receiving port number on which the data packet is received;
determining the type of communication link between the intermediate server and the target smart logistics device based on the target receiving port number and the correspondence between the port number and the type of communication link.

3. The data processing method according to claim 1, wherein the determining a target communication protocol adopted by the data packet during transmission based on the type of communication link between the intermediate server and the target smart logistics device, comprises:
obtaining a device type of the target smart logistics device;
generating target environment configuration information based on a device type of the target smart logistics device and the type of communication link between the intermediate server and the target smart logistics device;
determining a target communication protocol in the transmission of the data packet based on the target environment configuration information, and the correspondence between the environment configuration information and the communication protocol.

4. The data processing method according to claim 1, wherein the sending the encapsulated data packet to the logistics data server through the communication link between the intermediate server and the logistics data server, comprises:
generating a write message packet based on the encapsulated packet;
adding the write message packet to a message delivery queue;
sending the write message packet contained in the message sending queue to the logistics data server via the communication link between the intermediate server and the logistics data server.

5. The data processing method according to claim 4, wherein the sending the write message packet contained in the message sending queue to the logistics data server, comprises:
determining a priority of each write message packet in the message sending queue based on content of the write message packet;
determining an order in which each write message packet is sent in the message sending queue based on the priority of each write message packet;
sending the write message packets in the message sending queue to the logistics data server in sequence based on the sending order.

6. An electronic device, comprising:
one or more processors;
a storage device for storing one or more programs which, when the one or more programs are executed by the one or more processors, causes the one or more processors to implement a data processing method, wherein the data processing method comprises:
detecting, in response to a data packet from a target smart logistics device, a type of communication link between an intermediate server and the target smart logistics device;
determining a target communication protocol in a transmission of the data packet, based on the type of communication link between the intermediate server and the target smart logistics device;
parsing the data packet based on the target communication protocol to obtain parsed data;
encapsulating the parsed data according to a communication protocol corresponding to the type of the communication link between the intermediate server and the logistics data server to generate an encapsulated data packet; and
sending the encapsulated data packet to the logistics data server via the communication link between the intermediate server and the logistics data server.

7. The electronic device according to claim 6, wherein the detecting the type of communication link between the intermediate server and the target smart logistics device, comprises:
detecting a target receiving port number on which the data packet is received;
determining the type of communication link between the intermediate server and the target smart logistics device based on the target receiving port number and the correspondence between the port number and the type of communication link.

8. The electronic device according to claim 6, wherein the determining a target communication protocol adopted by the data packet during transmission based on the type of communication link between the intermediate server and the target smart logistics device, comprises:
obtaining a device type of the target smart logistics device;
generating target environment configuration information based on a device type of the target smart logistics device and the type of communication link between the intermediate server and the target smart logistics device;
determining a target communication protocol in the transmission of the data packet based on the target environment configuration information, and the correspondence between the environment configuration information and the communication protocol.

9. The electronic device according to claim 6, wherein the sending the encapsulated data packet to the logistics data server through the communication link between the intermediate server and the logistics data server, comprises:
generating a write message packet based on the encapsulated packet;
adding the write message packet to a message delivery queue;
sending the write message packet contained in the message sending queue to the logistics data server via the communication link between the intermediate server and the logistics data server.

10. The electronic device according to claim 9, wherein the sending the write message packet contained in the message sending queue to the logistics data server, comprises:
determining a priority of each write message packet in the message sending queue based on a content of the write message packet;
determining an order in which each write message packet is sent in the message sending queue based on the priority of each write message packet;
sending the write message packets in the message sending queue to the logistics data server in sequence based on the sending order.

11. A non-transitory computer readable medium having a computer program stored thereon, wherein the computer program when executed by a processor implements a data processing method, the data processing method comprising:
detecting, in response to a data packet from a target smart logistics device, a type of communication link between an intermediate server and the target smart logistics device;
determining a target communication protocol in a transmission of the data packet, based on the type of communication link between the intermediate server and the target smart logistics device;
parsing the data packet based on the target communication protocol to obtain parsed data;
encapsulating the parsed data according to a communication protocol corresponding to the type of the communication link between the intermediate server and the logistics data server to generate an encapsulated data packet; and
sending the encapsulated data packet to the logistics data server via the communication link between the intermediate server and the logistics data server.

12. The computer readable medium according to claim 11, wherein the detecting the type of communication link between the intermediate server and the target smart logistics device, comprises:
detecting a target receiving port number on which the data packet is received;
determining the type of communication link between the intermediate server and the target smart logistics device based on the target receiving port number and the correspondence between the port number and the type of communication link.

13. The computer readable medium according to claim 11, wherein the determining a target communication protocol adopted by the data packet during transmission based on the type of communication link between the intermediate server and the target smart logistics device, comprises:
obtaining a device type of the target smart logistics device;
generating target environment configuration information based on a device type of the target smart logistics device and the type of communication link between the intermediate server and the target smart logistics device;
determining a target communication protocol in the transmission of the data packet based on the target environment configuration information, and the correspondence between the environment configuration information and the communication protocol.

14. The computer readable medium according to claim 11, wherein the sending the encapsulated data packet to the logistics data server through the communication link between the intermediate server and the logistics data server, comprises:
generating a write message packet based on the encapsulated packet;
adding the write message packet to a message delivery queue;
sending the write message packet contained in the message sending queue to the logistics data server via the communication link between the intermediate server and the logistics data server.

15. The computer readable medium according to claim 14, wherein the sending the write message packet contained in the message sending queue to the logistics data server, comprises:
determining a priority of each write message packet in the message sending queue based on a content of the write message packet;
determining an order in which each write message packet is sent in the message sending queue based on the priority of each write message packet;
sending the write message packets in the message sending queue to the logistics data server in sequence based on the sending order.
